(19) United States
(12) Patent Application Publication
(10) Pub. No.: US 2002/0059516 A1
(43) Pub. Date: May 16, 2002

(54) Securing Voice over IP traffic

(76) Inventors: Esa Turtiainen, Espoo (FI); Tommi Linnakangas, Espoo (FI); Juha-Petri Karna, Espoo (FI); Goran Schultz, Pargas (FI); Seppo Lindborg, Vantaa (FI)

Correspondence Address: Ronald L. Grudziecki, Esquire, BURNS, DOANE, SWECKER & MATHIS, L.L.P., P.O. Box 1404, Alexandria, VA, 22313-1404, US

(21) Appl. No.: 10/003,776

(22) Filed: Nov. 15, 2001

(30) Foreign Application Priority Data
Nov. 16, 2000 (GB) 0028068.5

(51) Int. Cl. H04L 9/00

(52) U.S. Cl. 713/153

(57) ABSTRACT

A method of sending streamed data over an IP network from a first node 1 to a second node 4, the method comprising using Internet Key Exchange (IKE) to establish an IKE security association (SA) between the first and second nodes 1,4. A shared secret is established between the first and second nodes using the IKE SA, and the streamed data encrypted at the first node 1 with a cipher using the shared secret or a key derived using the shared secret. IP datagrams are constructed containing in their payload, segments of the encrypted streamed data, the datagrams not including an IPSec header or headers. The IP datagrams are then sent from the first node 1 to the second node 4.

### FIELD OF THE INVENTION

The present invention relates to a method and apparatus for securing Voice over IP (VoIP) traffic.

### BACKGROUND TO THE INVENTION

There is an ever increasing demand for mobility in communications systems. However, this demand must be met in a manner which provides for the secure transfer of data between communicating parties. A concept known as the Virtual Private Network (VPN) has recently been introduced, with the aim of satisfying, by a combination of encryption and secure access, this demand. A VPN may involve one or more corporate Local Area Networks (LANs) or intranets, as well as users coupled to “foreign” LANs, the Internet, wireless mobile networks, etc.

An Internet Engineering Task Force (IETF) standard known as IPsec (RFC2401) has been defined and provides for the creation of a secure connection between parties in a VPN over IPv4 and IPv6. In the IPsec model the end points of the secure connection are identified by their IP addresses.

In order to allow IPSec packets to be properly encapsulated and decapsulated it is necessary to associate security services and a key between the traffic being transmitted and the remote node which is the intended recipient of the traffic. The construct used for this purpose is a “Security Association” (SA). SAs are negotiated between peer nodes using a mechanism known as “Internet Key Exchange” (IKE), and are allocated an identification known as a “Security Parameter Index” (SPI). The appropriate SA is identified to the receiving node by including the corresponding SPI in the headers of the transmitted data packets. Details of the existing SAs and the respective SPIs are maintained in a Security Association Database (SAD) which is associated with each IPSec node.

As already noted, IPSec SAs are negotiated using the IKE mechanism. More particularly, IPSec SAs make use of IKE phase 2. IKE phase 1 involves the negotiation of an IKE SA. When IKE phase 1 is initiated between two nodes, communications are carried out in the open. The mechanisms used must therefore be extremely secure and inevitably computationally intensive. At the end of phase 1 both nodes are authenticated to each other, and a shared secret is established between them. IKE phase 2 makes use of the IKE SA to negotiate one or more IPSec SAs. As the phase 2 negotiations are carried out using a secure mechanism, they can be much less computationally intensive than the phase 1 negotiation. Whilst a new IKE SA may be negotiated only infrequently (e.g. one a day or once a week), IPSec SAs may be negotiated every few minutes.

IPSec makes use of one or both of the Authentication Header (AH) and Encapsulation Security Payload (ESP) protocols which in turn make use of the corresponding established IPSec SA. Both of these protocols provide for the authentication of sent data packets whilst ESP provides in addition for the encryption of user data. The use of AH and/or ESP is agreed upon by the communicating nodes during the IKE negotiations.

The precise way in which IPSec is implemented in a system depends to a large extent upon the security policy of the organisation wishing to employ IPSec. For example, the organisation may specify end-points (e.g. user terminals) to which IP packets may be sent, or from which they may be received, the particular security levels to be used for encrypting packets, etc. Policy is stored in a Security Policy Database (SPD) which is also associated with each IPSec node. Typically, the SPD is distributed amongst a plurality of entities of the IPSec node.

It is expected that in the very near future IP networks will be used to carry significant volumes of voice data. The use of IP networks for real time voice communication is referred to as Voice over IP (VoIP). Indeed VoIP already exists, although in practice its applications are limited by the poor bandwidth and quality offered by current IP standards and networks. As IP standards are revised and new standards created, it can be expected that more use will be made of VoIP.

The Internet is an open network in as much as unauthorised third parties can potentially intercept data and attempt to fraudulently transmit data. This is one of the main reasons for the creation of IPSec. Of course it is desirable to secure VoIP traffic and proposals have been made to allow the integration of VoIP with IPSec, such that VoIP traffic can be secured using the ESP protocol (which includes provision for data encryption). This solution is not without its problems however. The nature of speech and the real time transmission of speech requires the sending of relatively small data packets, containing in the region of 30-50 bits, with a high frequency. A typical ESP header, plus the ESP trailer (and authentication data) contains up to 160 bits, resulting in a doubling or trebling of the total packet size. This does not represent an efficient use of the IP resources. A similar problem applies to the transmission of other real time streamed data such as videoconferencing and multimedia data.

### SUMMARY OF THE INVENTION

The inventors of the present invention have recognised that, whilst IPSec does not represent an optimal solution for VoIP or other streamed data, it is likely to be installed on many terminals and devices employing streamed data. Certain components of IPSec may be advantageously employed with streamed data, providing that these components do not add excessively to the size of data packet.

According to a first aspect of the present invention there is provided a method of sending streamed data over an IP network from a first node to a second node, the method comprising:

using Internet Key Exchange (IKE) to establish an IKE security association (SA) between the first and second nodes;

using the IKE SA to establish an IPSec SA between the first and second nodes;

encrypting the streamed data at the first node with a cipher using a shared secret forming part of said IPSec SA;

constructing IP datagrams containing in their payload segments of the encrypted streamed data, the datagrams not including an IPSec header or headers; and

sending the IP datagrams from the first node to the second node.

The present invention is particularly applicable to the secure transmission of VoIP data or videoconferencing data. It will be appreciated that such data does generally not require authentication as the data is self-authenticating. The main security concern is that of third parties monitoring the data, and this can be done by using IKE to generate an encryption key.

The method of the present invention may be used to secure streamed data sent between two nodes which represent end points for the data, e.g. two telephone terminals or PCs, or between two nodes which tunnel data between respective end points (e.g. gateways and firewalls).

According to a second aspect of the present invention there is provided apparatus for sending streamed data over an IP network to a peer node, the apparatus comprising:

processing means and memory containing software instructions for implementing IPSec protocols;

an application for delivering streamed data;

means for employing components of said processing means and memory containing software instructions for using Internet Key Exchange (IKE) to establish an IKE security association (SA) between the first and second nodes;

means for using the IKE SA to establish an IPSec SA between the first and second nodes, the IKE SA comprising a shared secret;

means for encrypting the streamed data with a cipher using the shared secret;

means for constructing IP datagrams containing in their payload segments of the encrypted streamed data, the datagrams not including an IPSec header or headers; and

transmission means for sending the IP datagrams from the first node to the second node.

The apparatus of the present invention may be an end user terminal such as a telephone, communicator, PDA or palmtop computer, or a personal computer (PC). Alternatively, the apparatus may be a firewall or gateway coupled to an end point which is the source of the streamed data.

### BRIEF DESCRIPTION OF THE DRAWINGS

FIG. 1 illustrates schematically a Virtual Private Network (VPN) comprising an intranet;

FIG. 2 illustrates at a general level the signalling between two nodes of the VPN of FIG. 1 during a secure data connection establishment process;

FIG. 3 illustrates at a more detailed level the signalling involved in an IKE phase 1 of the process of FIG. 2;

FIG. 4 illustrates a Quick Mode message exchange of an IKE phase 2 of the process of FIG. 2; and

FIG. 5 is a flow diagram illustrating a secure VoIP method according to an embodiment of the present invention.

### DETAILED DESCRIPTION OF A PREFERRED EMBODIMENT

The method which will now be described makes use of features described in the following documents: [IPsec] RFC 2401, Security Architecture for the Internet Protocol, November 1998; [REKEY] Internet Draft, IPsec Re-keying Issues; [IKE] RFC 2409, The Internet Key Exchange (IKE), November 1998; [ISAKMP] RFC 2408, Internet Security Association and Key Management Protocol, November 1998; [INTDOI] RFC 2407, The Internet Security Domain of Interpretation for ISAKMP, November 1998. Reference should be made to these documents for a fuller understanding of the method.

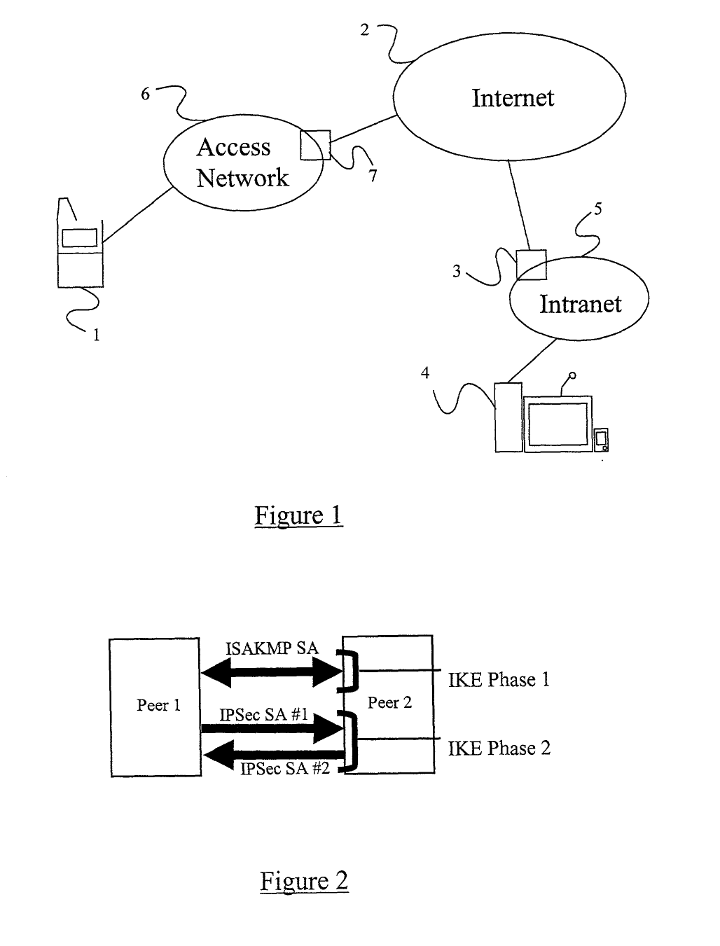

FIG. 1 illustrates a situation where a mobile wireless device 1 may use the Internet 2 to connect to an organisation's firewall or Security Gateway (SG) 3, and then to gain access to some correspondent host (e.g. a server or other machine) 4 connected to the organisation's intranet (i.e. corporate LAN) 5. An access network 6 couples the mobile host 1 to the Internet 2 via a gateway 7. The access network may be for example a GSM network using GPRS, or may be a third generation network such as a UMTS network. The Mobile device 1 includes hardware and software components for implementing IP, including IPSec. Using IKE (phase 1 and phase 2 as illustrated in FIG. 2), the mobile terminal can create IPSec SAs with which it can securely exchange data with the correspondent host 4.

As has been explained above, IPSec results in large headers (and other components) being added to data packets and is therefore not suitable for VoIP traffic. In order to overcome this problem, the embodiment of the invention described here makes use only of the IKE component of IPSec.

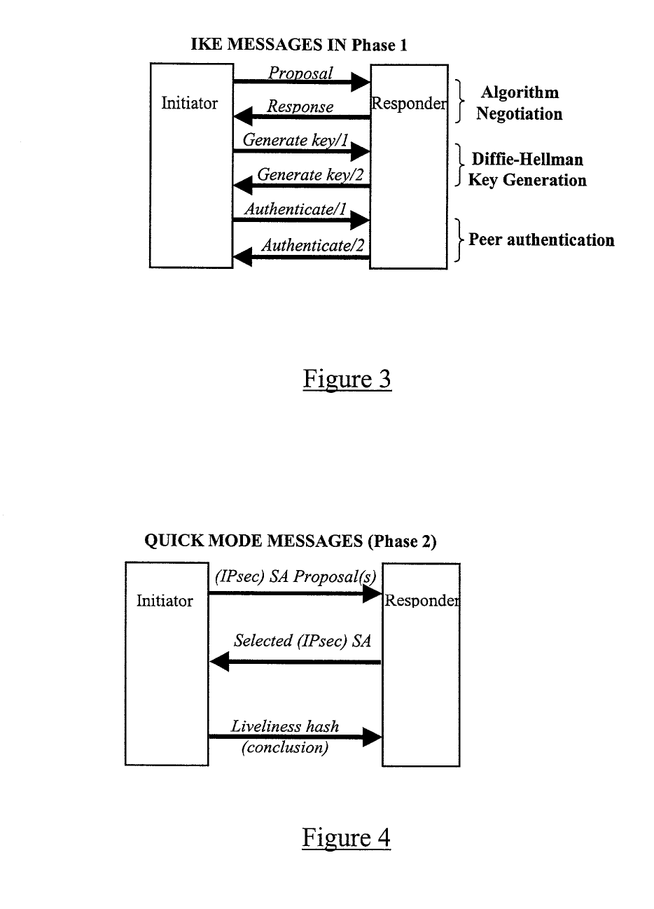

Assuming that VoIP traffic is to be exchanged between the mobile device 1 (peer 1) and the correspondent host 4 (peer 2). Both peer nodes will make use of software applications which provides the interface to the user (this application may present a simulated telephone on the display of the correspondent host 4). A VoIP communication is initiated by one of the peer nodes sending a request to the other node. An IKE phase 1 negotiation is then carried out between the peers using ISAKMP—this is illustrated in FIG. 3. The result of this negotiation is the authentication of the peers to one another, and the creation of an IKE (or ISAKMP) SA which defines amongst other things the encryption algorithm (to be used for negotiating IPSec SAs if required). The Phase 1 negotiation also results in the generation of a secret (or “key”) which is shared between the two nodes.

The shared secret may be used to encrypt the VoIP data directly, using the encryption algorithm and other associated parameters associated with the IKE SA. In this case, the relevant encryption data is made available to the VoIP applications. However, rather than use the IKE SA data, it may be preferable to enter IKE phase 2 and negotiate a pair of IEPSec SAs (one for each transmission direction). IKE phase 2 is illustrated in more detail in FIG. 4. The IPSec SA data relevant to encryption, including a pair of encryption keys, is then passed to the VoIP applications. The advantage of using IKE phase 2 is that the IKE phase 1 negotiation need only be done occasionally, with IKE phase 2 being carried out each time a new connection is required.

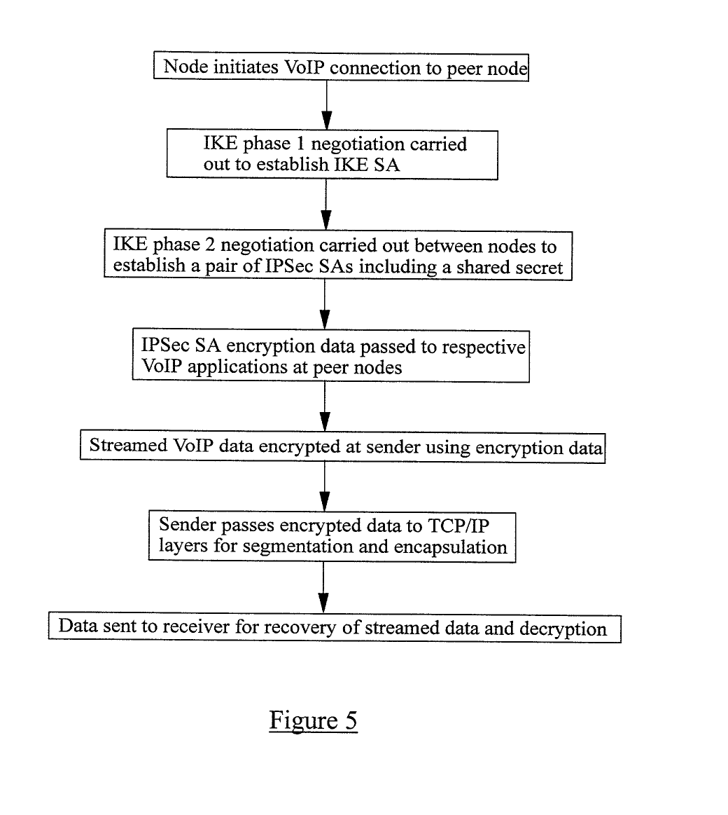

Whichever SA is selected (IKE or IPSec), the VoIP application at the transmitting peer uses the encryption data to encrypt the streamed VoIP data generated by the application. The encrypted data is then passed to the TCP/IP layers for segmentation and encapsulation with standard IP headers. As the IP data is not subjected to the complete IPSec procedure, the resulting IP packets do not include IPSec headers including AH and ESP headers. At the receiving peer, the IP data packets are decapsulated and the reconstructed, encrypted data stream passed to the VoIP application for decryption. FIG. 5 illustrates the interaction of the VoIP application at one of the peers with the IPSec and IP protocol layers.

FIG. 6 is a flow diagram illustrating a method of setting up a VoIP connection between two peers.

It will be appreciated by the person of skill in the art that various modifications may be made to the above described embodiments without departing from the scope of the present invention. For example, in some circumstances security may only be required between the access network IP gateway 7 and the intranet IP gateway 3, in which case an IKE SA (and IPSec SA if necessary) will be negotiated between these nodes upon initiation of a VoIP communication by one of the end points 1,4. It is also envisaged that encryption may be used only between the device 1 and the intranet gateway 3 or between the access network gateway 7 and the correspondent host 4. It will also be appreciated that whilst the invention has been exemplified with reference to IKE, IKE is an evolving standard and as such the invention can equally be applied to derivatives of the current IKE standard.

1. A method of sending streamed data over an IP network from a first node to a second node, the method comprising:
using Internet Key Exchange (IKE) to establish an IKE security association (SA) between the first and second nodes;
using the IKE SA to establish an IPSec SA between the first and second nodes;
encrypting the streamed data at the first node with a cipher using a shared secret forming part of said IPSec SA;
constructing IP datagrams containing in their payload segments of the encrypted streamed data, the datagrams not including an IPSec header or headers; and
sending the IP datagrams from the first node to the second node.

2. A method according to claim 1, wherein said streamed data is VoIP data or videoconferencing data.

3. A method according to claim 1, wherein said peer nodes are end points for the data.

4. A method according to claim 1, wherein said peer nodes tunnel data between respective end points.

5. Apparatus for sending streamed data over an IP network to a peer node, the apparatus comprising:
processing means and memory containing software instructions for implementing IPSec protocols;
an application for delivering streamed data;
means for employing components of said processing means and memory containing software instructions for using Internet Key Exchange (IKE) to establish an IKE security association (SA) between the first and second nodes;
means for using the IKE SA to establish an IPSec SA between the first and second nodes, the IKE SA comprising a shared secret;
means for encrypting the streamed data with a cipher using the shared secret;
means for constructing IP datagrams containing in their payload segments of the encrypted streamed data, the datagrams not including an IPSec header or headers; and
transmission means for sending the IP datagrams from the first node to the second node.

6. Apparatus according to claim 5, the apparatus being an end user terminal such as a telephone, communicator, PDA or palmtop computer, or a personal computer (PC).

7. Apparatus according to claim 6, the apparatus being a firewall or gateway coupled to an end point which is the source of the streamed data.
